(19) United States
(12) Patent Application Publication
(10) Pub. No.: US 2026/0323502 A1
(43) Pub. Date: Oct. 15, 2026

(54) COMPUTATION SERVICE-BASED CELL SELECTION FOR IDLE-MODE MOBILITY

(71) Applicant: QUALCOMM Incorporated, San Diego, CA (US)

(72) Inventors: Navid ABEDINI, Basking Ridge, NJ (US); Tao LUO, San Diego, CA (US); Hua WANG, Basking Ridge, NJ (US); Junyi LI, Greentown, PA (US); Sony AKKARAKARAN, Poway, CA (US); Qing LI, Princeton Junction, NJ (US); Jelena DAMNJANOVIC, Del Mar, CA (US); Qian ZHANG, Basking Ridge, NJ (US)

(21) Appl. No.: 19/544,820

(22) Filed: Feb. 19, 2026

Related U.S. Application Data
(60) Provisional application No. 63/787,432, filed on Apr. 11, 2025.

(51) Int. Cl. H04W 48/20; H04W 24/08; H04W 72/20

(52) U.S. Cl. CPC H04W 48/20; H04W 24/08; H04W 72/20

(57) ABSTRACT

This disclosure provides methods, components, devices and systems for computation service-based cell selection for idle-mode mobility. For example, a user equipment (UE) may select a cell for communications with a wireless device (e.g., a network entity, a second UE) in accordance with computation service information and, in some cases, one or more prioritization criteria. The computation service information may indicate computation services supported by each wireless device. In some examples, the UE may be configured to use a computation service and may select cells associated with a wireless device that supports the computation service. In some other examples, the UE may offer a computation service to other devices and may select cells associated with a wireless device that supports features associated with the computation service. The UE may receive additional information associated with the computation services supported by the wireless device via control signaling.

### CROSS REFERENCE

The present Application for Patent claims the benefit of U.S. Provisional Patent Application No. 63/787,432 by ABEDINI et al., entitled “COMPUTATION SERVICE-BASED CELL SELECTION FOR IDLE-MODE MOBILITY,” filed Apr. 11, 2025, assigned to the assignee hereof, and which is expressly incorporated by reference in its entirety herein.

### TECHNICAL FIELD

This disclosure relates generally to wireless communication, and more specifically to systems, devices, methods, and techniques associated with computation service-based cell selection for idle-mode mobility.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a UE is described. The method may include receiving control signaling including computation service information indicating one or more computational services supported by at least one of a set of multiple wireless communication devices, performing, based on the computation service information, a cell selection procedure to select a first cell corresponding to a first wireless communication device of the set of multiple wireless communication devices, where the computation service information indicates that a first computational service of the one or more computational services is supported by the first wireless communication device via the first cell, and monitoring the first cell for signaling from the first wireless communication device based on the cell selection procedure.

A UE for wireless communication is described. The UE may include a processing system that includes processor circuitry and memory circuitry that stores code. The processing system may be configured to cause the UE to receive control signaling including computation service information indicating one or more computational services supported by at least one of a set of multiple wireless communication devices, perform, based on the computation service information, a cell selection procedure to select a first cell corresponding to a first wireless communication device of the set of multiple wireless communication devices, where the computation service information indicates that a first computational service of the one or more computational services is supported by the first wireless communication device via the first cell, and monitor the first cell for signaling from the first wireless communication device based on the cell selection procedure.

Another UE for wireless communication is described. The UE may include means for receiving control signaling including computation service information indicating one or more computational services supported by at least one of a set of multiple wireless communication devices, means for performing, based on the computation service information, a cell selection procedure to select a first cell corresponding to a first wireless communication device of the set of multiple wireless communication devices, where the computation service information indicates that a first computational service of the one or more computational services is supported by the first wireless communication device via the first cell, and means for monitoring the first cell for signaling from the first wireless communication device based on the cell selection procedure.

A non-transitory computer-readable medium storing code for wireless communication is described. The code may include instructions executable by one or more processors to receive control signaling including computation service information indicating one or more computational services supported by at least one of a set of multiple wireless communication devices, perform, based on the computation service information, a cell selection procedure to select a first cell corresponding to a first wireless communication device of the set of multiple wireless communication devices, where the computation service information indicates that a first computational service of the one or more computational services is supported by the first wireless communication device via the first cell, and monitor the first cell for signaling from the first wireless communication device based on the cell selection procedure.

In some examples of the method, user equipment (UEs), and non-transitory computer-readable medium described herein, the computation service information may indicate one or more computational service identifiers corresponding to the one or more computational services.

In some examples of the method, user equipment (UEs), and non-transitory computer-readable medium described herein, performing the cell selection procedure may include operations, features, means, or instructions for selecting the first cell in accordance with a priority of at least one cell including the first cell, where the priority may be based on the computation service information.

In some examples of the method, user equipment (UEs), and non-transitory computer-readable medium described herein, the priority may be based on whether a respective wireless communication device of the set of multiple wireless communication devices supports the first computational service.

In some examples of the method, user equipment (UEs), and non-transitory computer-readable medium described herein, the computation service information may be for a network entity and the set of multiple wireless communication devices include one or more network entities.

In some examples of the method, user equipment (UEs), and non-transitory computer-readable medium described herein, the computation service information may be for one or more wireless communication devices in communication with a network entity and the one or more wireless communication devices include one or more second UEs, one or more edge computing devices, or any combination thereof.

### BRIEF DESCRIPTION OF THE DRAWINGS

FIG. 1 shows an example of a wireless communication system.

FIG. 2 shows an example of a signaling configuration that supports computation service-based cell selection for idle-mode mobility.

FIG. 3 shows an example of a process flow that supports computation service-based cell selection for idle-mode mobility.

FIG. 4 shows a block diagram of a processing system that supports computation service-based cell selection for idle-mode mobility.

FIG. 5 shows a diagram of a system including a device that supports computation service-based cell selection for idle-mode mobility.

FIG. 6 shows a flowchart illustrating methods that support computation service-based cell selection for idle-mode mobility.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, wireless devices may implement computation services to improve performance for processes (e.g., applications) that involve real-time data processing and low-latency communications. For example, legacy (e.g., 5G) network architecture may support Multi-User Edge Computing (MEC) architecture, where wireless devices implement a computation service via a cloud server. However, updates to device capability for current (e.g., 6G) network architecture may support implementation of computation services at network nodes (e.g., network entities) and user equipments (UEs) within a wireless communication system. In some examples, a network node may offer a computation service, and a UE may establish a connection with the network node to utilize the computation service. In some other examples, the UE may offer a computation service and may establish a connection with the network node such that communications with the network node utilize the computation service. In some cases, a UE may be performing mobility operations in an idle mode. To establish communications with another wireless device, the UE may perform a cell selection procedure. It may be beneficial for the UE to perform cell selection in consideration of computation services associated with the UE.

Various aspects of the present disclosure are related to computation service-based cell selection for idle-mode mobility. In some examples, a UE may receive computation service information indicating one or more computation services associated with multiple wireless devices. The UE may select a cell for communications with a wireless device (e.g., a network entity, a second UE) in accordance with computation service information associated with the UE and with the wireless device. For example, the UE may be associated with a computation service and may select one or more cells associated with a wireless device that supports the same computation service. In some cases, the UE may be a client UE that utilizes the computation service to perform communications. Accordingly, the computation service information may indicate computation services that are offered by each wireless device. In some other cases, the UE may be a server UE that offers the computation service to other devices for performing communications. The computation service information may indicate features supported by each wireless device that are associated with the computation service offered by the UE. The UE may perform cell selection using the computation service information and, in some cases, in accordance with one or more cell prioritization criteria.

Particular aspects of the subject matter described in this disclosure can be implemented to realize one or more of the following potential advantages. In some examples, by performing cell selection in accordance with computation service information, the described techniques can be used to improve overall energy efficiency, latency, and system resource utilization for cell selection. Specifically, by performing cell selection at a client UE in accordance with computation service information, the described techniques can be used to reduce connection establishment overhead and latency and may improve the quality of the computation service. Similarly, by performing cell selection at a server UE in accordance with computation service information, the described techniques can be used to facilitate more efficient usage of the service capabilities supported by the server UE.

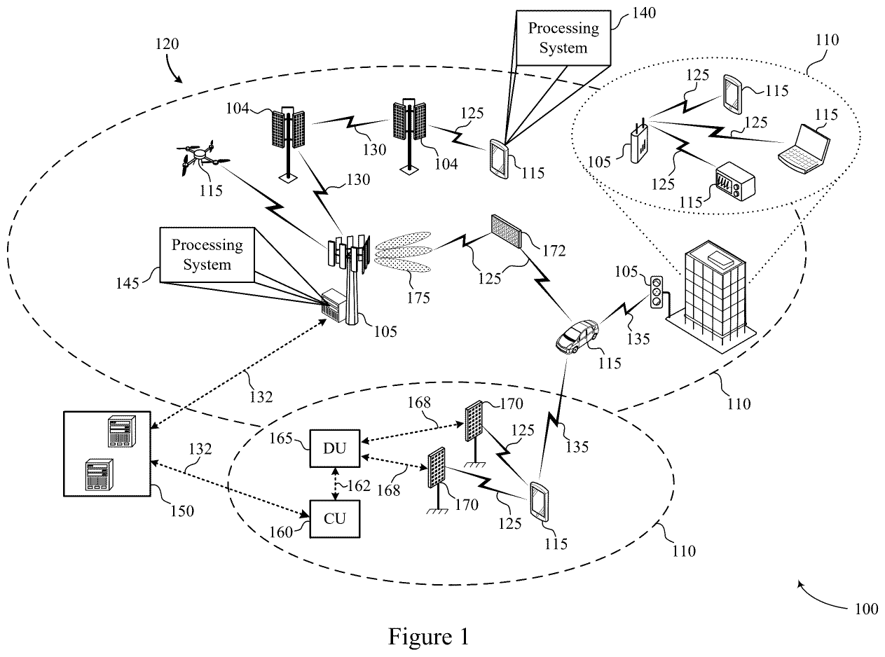

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, multiple-input-multiple-output (MIMO) communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR 1), between 425 MHz and 7.125 GHz), a mid-band (such as Frequency Range 3 (FR 3), between 7.125 GHz and 24.25 GHz), or an upper frequency band (such as Frequency Range 2 (FR 2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a SBFD configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, orthogonal frequency division multiplexing (OFDM) symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as OFDM or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for computation service-based cell selection for idle-mode mobility. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support computation service-based cell selection, which may improve overall energy efficiency, latency, and system resource utilization for cell selection.

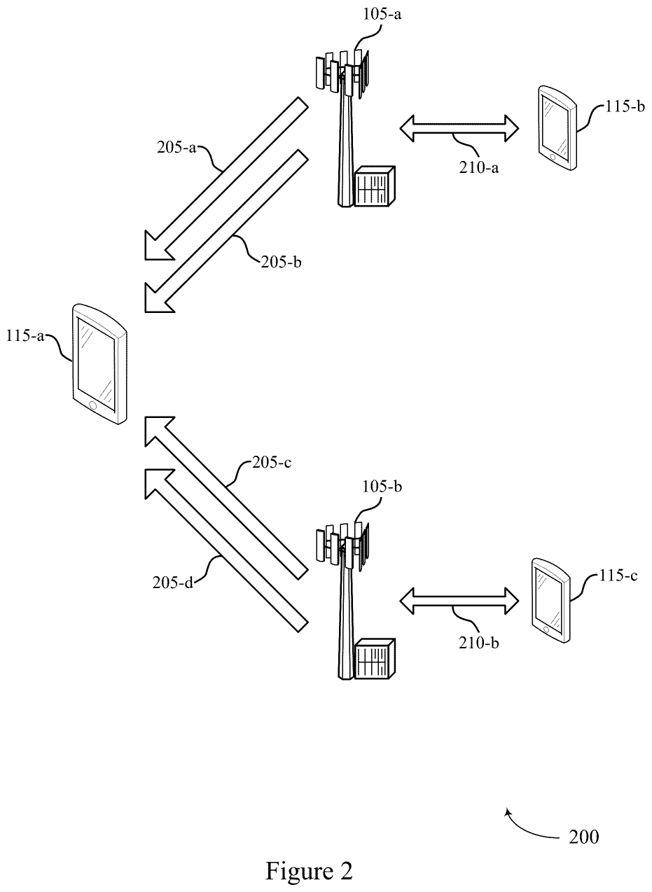

FIG. 2 shows an example of a signaling configuration 200 that supports computation service-based cell selection for idle-mode mobility. The signaling configuration 200 may depict communications between multiple wireless devices (e.g., wireless communication devices) including a first UE 115-a, a second UE 115-b, a third UE 115-c, a first network entity 105-a, and a second network entity 105-b. In the example of FIG. 2, the first UE 115-a may be in an idle mode (e.g., an RRC idle mode). That is, the first UE 115-a may not have established communications with either of the first network entity 105-a or the second network entity 105-b. The second UE 115-b may be in communication with the first network entity 105-a and may communicate via a communication link 210-a (e.g., a cellular link). The third UE 115-c may be in communication with the second network entity 105-b and may communicate via a communication link 210-b.

In some examples, the wireless devices in the signaling configuration 200 may support the usage of computation services (e.g., computational services) for communications. Computation services may leverage computing resources and storage resources to reduce latency and improve performance for applications that implement real-time data processing and low-latency communications. In some implementations, such computation services may be stored in or otherwise associated with a cloud server in communication with the first UE 115-a, the second UE 115-b, the third UE 115-c, the first network entity 105-a, the second network entity 105-b, or any combination thereof. However, in the example of FIG. 2, the first UE 115-a, the second UE 115-b, the third UE 115-c, the first network entity 105-a, the second network entity 105-b, or any combination thereof, may be capable of supporting computation services. For example, improved device capabilities (e.g., processing capabilities, memory capabilities) of 6G devices may support implementing such computation services at the wireless devices of the signaling configuration 200. In some examples, the UEs 115 described by the signaling configuration 200 may be examples of client UEs 115 and server UEs 115. A client UE 115 may be configured to perform processes that utilize a computation service. A server UE 115 may host a computation service and may be capable of providing the computation service to a network entity 105 or other UEs 115.

In some examples, the first UE 115-a may be a client UE 115. In such examples, a network entity 105 (e.g., the first network entity 105-a) may host (e.g., offer) a computation service. Additionally, or alternatively, the network entity 105 may be associated with one or more connected (e.g., camped) UEs 115 that offer partial computation services. Communications between UEs 115 may be facilitated by the network entity 105. For example, in FIG. 2, direct communication between the first UE 115-a and the second UE 115-b (e.g., sidelink communications) may be managed by the first network entity 105-a. In another example, in FIG. 2, communications between the first UE 115-a and the second UE 115-b may be through (e.g., relayed through) the first network entity 105-a.

In some other examples, the first UE 115-a may be a server UE 115. In such examples, a network entity 105 (e.g., the first network entity 105-a) may support features that facilitate usage of the computation service supported by the first UE 115-a. For example, the network entity 105 may support features associated with signaling support (e.g., paging) to notify the first UE 115-a about service requests, to locally coordinate connections, to coordinate computation load balancing, or any combination thereof, among other features.

In some examples, the first UE 115-a may establish communications with a network entity 105 (e.g., the first network entity 105-a, the second network entity 105-b). For example, the first UE 115-a may be in a mobility scenario (e.g., idle mode mobility), where the first UE 115-a selects a new network entity 105 for communications based on movement of the first UE 115-a (e.g., in space). To establish communications with the network entity 105, the first UE 115-a may select a network entity 105 for communications by performing a cell selection procedure. Each network entity 105 may be associated with a group of cells 205. For example, the first network entity 105-a may be associated with a first cell 205-a and a second cell 205-b, and the second network entity 105-b may be associated with a third cell 205-c and a fourth cell 205-d. Each cell 205 may be associated with a range of frequencies (e.g., radio frequencies) used for communications between the network entity 105 and another wireless device (e.g., the first UE 115-a, the second UE 115-b). Additionally, or alternatively, the first UE 115-a may establish communications with a UE 115 (e.g., the second UE 115-b, the third UE 115-c). For example, the first UE 115-a may select a UE 115 to connect to via sidelink.

In some examples where the first UE 115-a is associated with a computation service, the first UE 115-a may either receive the computation service (e.g., if the first UE 115-a is a client UE 115) or provide the computation service (e.g., if the first UE 115-a is a server UE 115) if the first UE 115-a is camped on (e.g., connected with) a cell 205. Accordingly, it may be beneficial to extend cell selection procedures to consider or otherwise support the usage of computation services in the signaling configuration 200. As such, various aspects of the present disclosure are related to computation service-based cell selection for idle-mode mobility. The first UE 115-a may receive computation service information that indicates computation services supported by each network entity 105. The first UE 115-a may select a cell 205 for communications based on computation service information associated with each network entity 105 in the signaling configuration 200.

The first UE 115-a may prioritize cells 205 for cell selection in accordance with computation service information associated with each cell 205. In some examples where the first UE 115-a is a client UE 115, the first UE 115-a may consider network entities 105 that support the computation service requested by the first UE 115-a when examining cells 205 for cell selection. For example, the first UE 115-a may prioritize selecting any suitable cell belonging to a group of cells (or a network-entity that offer a desired computation service. In other examples where the first UE 115-a is a server UE 115, the first UE 115-a may consider network entities 105 that support features that facilitate more efficient usage of the computation service supported by the first UE 115-a when the examining cells 205 for cell selection.

In some cases, the first UE 115-a may prioritize the cells 205 that support the computation service associated with the first UE 115-a. In the example of FIG. 2, the first UE 115-a may be associated with (e.g., use, support) a first computation service. In some cases, the first UE 115-a may receive computation service information indicating that the first network entity 105-a supports the first computation service via the first cell 205-a. In such cases, the first UE 115-a may consider the first cell 205-a to have a highest priority of the cells 205. In another case, the computation service information may indicate that the first network entity 105-a supports the first computation service via both the first cell 205-a and the second cell 205-b, and the first UE 115-a may consider both the first cell 205-a and the second cell 205-b to have a highest priority of the cells 205. Similarly, the first UE 115-a may receive computation service information indicating that the second network entity 105-b does not support the first computation service via the third cell 205-c and the fourth cell 205-d. In such cases, the first UE 115-a may consider the third cell 205-c and the fourth cell 205-d to have the lowest priority of the cells 205.

In some examples where there are multiple cells 205 of interest (e.g., multiple candidate cells 205 that offer a desired computation service) to the first UE 115-a, the first UE 115-a may select one of the cells 205 for communications. Additionally, or alternatively, the first UE 115-a may select from the multiple candidate cells 205 in accordance with one or more rules (e.g., criteria). For example, the first UE 115-a may evaluate one or more metrics of the cell 205, including a channel quality, a channel strength, a traffic load, a computational load or other computation service status, computation service availability, a type of the computation service (e.g., the first computation service) and one or more metrics (e.g., computation amount) associated with the type of computation service, or any combination thereof. As an example, the first UE 115-a may prioritize selecting a cell 205 that satisfies one of the above metrics, such as a channel quality exceeding a threshold or being within a threshold quality from another cell 205 (e.g., a highest rank cell 205), whether the cell 205 (e.g., the associated network entity 105) can currently provide the first computation service, whether the cell 205 can support the anticipated load or quality of service for the requested computation service, whether the cell 205 can provide a computation service that exceeds a quality of service threshold (e.g., a first cell and a first corresponding network entity may provide X% better computation service in terms latency, amount of computation relative to a second cell and a second corresponding network entity), or any combination thereof.

In some examples, there may be multiple computation services supported by the wireless devices in the signaling configuration 200. Each computation service may be associated with (e.g., may support, may be defined with) different computation quality of service requirements (e.g., Tera Operations per Second (TOPS), memory), different types of communications or communication traffic (e.g., artificial intelligence (AI), distributed AI, XR, IoT, Large-Scale Fading (LSF)), different types or classes of models and agents, or any combination thereof. Each of the multiple computation service may be defined by (e.g., associated with) a respective service identifier (ID). Multiple services, models, agent IDs, or the like, may be defined by a wireless standard, by the network entity 105, pre-configuration, Operations, Administration, and Maintenance (OAM), or the like. In cases where the first UE 115-a is a client UE 115, the first UE 115-a may be configured to use, or may be registered, authorized, or both, for one or multiple service IDs. In cases where the first UE 115-a is a server UE 115, the first UE 115-a may be capable of providing, or may be registered or authorized to provide one or multiple service IDs. Prioritization of cells 205 for cell selection may be based on the support of service IDs associated with the first UE 115-a.

The first UE 115-a may receive the computation service information via control signaling from the network entities 105. Such computation service information may indicate one or more supported computation services in a list of service IDs supported (e.g., offered) by one or more of a cell 205, a group of cells 205, a network entity 105, a frequency, a list of frequencies, a geographic area, or any combination thereof. In some examples, the first UE 115-a may receive the computation service information via one or more system information blocks (SIBs) (e.g., SIBx). For example, a network entity 105 (e.g., the first network entity 105-a) may advertise (e.g., indicate) computation service information for the first network entity 105-a via a SIBx (e.g., SIB1, other or new SIBs, or a combination thereof). In some cases, the first network entity 105-a may also advertise computation service information for other neighboring network entities (e.g., the second network entity 105-b), other cells 205, or an area (e.g., computation area) that includes the first network entity 105-a.

In an example, a SIB may indicate that a computation service is associated with one or more network entities, and the UE 115 may acquire a full cell ID (including the gNB ID or other network entity ID) to determine whether that cell provides a desired computation service. In one example, SIB1 may indicate that a cell, network entity, or both, offers a first computation service to a client UE, offers one or more features for use of the first or a second computation service provided by a server UE, or both. In such examples, more information on the first or the second computation service may be provided in other SIBs or other messaging. Alternatively, or additionally, a network entity 105 may indicate partial information in a first SIB (e.g., SIB1) and may provide additional information in follow-up signaling. For example, the first network entity 105-a may transmit a SIB1 indicating that the first network entity 105-a supports the first computation service and may transmit a second SIB (e.g., SIB2) indicating information (e.g., parameters) associated with the first computation service.

In some other examples, the first UE 115-a may receive the computation service information via dedicated RRC signaling (e.g., before receiving an RRC release or RRC suspend message). Additionally, or alternatively, the first UE 115-a may be configured with the computation service information via operations and management (OAM) signaling. In another example, the computation service information associated with each cell 205 may be implicitly indicated based on an association between each cell 205 and a respective network entity 105. For example, the first UE 115-a may acquire one or more cell IDs. Each cell ID may also include a gNB ID, and the first UE 115-a may determine whether the cell supports the first computation service in accordance with the gNB ID and whether the corresponding network entity 105 supports the first computation service.

The first UE 115-a may receive additional computation service information via the control signaling or via additional control signaling. Such additional computation service information may include computation resource availability (e.g., central processing unit (CPU), graphics processing unit (GPU), memory, floating-point operations per second (FLOPS), accelerators for specific computation tasks (e.g., fast Fourier transforms (FFT), large matrix multiplication), or any combination thereof), computation service availability, a current computational load of a computation task, computation service timing information (e.g., an expected, maximum, and range value for a delay to execute and deliver a computation service), computation service pricing information, or any combination thereof. In some examples, the additional computation service information may be associated with and provided by a network entity 105 (e.g., via control signaling). In some other examples, the additional computation service information may be aggregated information from other wireless devices (e.g., the second UE 115-b, a MEC server) providing computation services that are connected to the network entity 105.

In some examples, different sets of the additional computation service information may be provided for different types of service providers. For example, the additional computation service information for different types of service providers may include information specific to a network entity 105, information associated with one or more nearby UEs 115, information associated with a MEC server, or any combination thereof. Additionally, or alternatively, different sets of the additional computation service information may be provided based on specific information included in the additional computation service information. For example, the contents of the additional computation service information may vary for different computation service prices, different computation tasks, different amounts of delay, or any combination thereof.

In some examples, the additional computation service information may be dynamically signaled to the first UE 115-a. For example, the additional computation service information may be transmitted via a broadcast channel defined to carry computation service-related information, a configuration for a computation service, or both. Additionally, or alternatively, the additional computation service information may be transmitted via paging signaling, random access channel (RACH) signaling (e.g., a RACH Msg2, RACH Msg4, RACH MsgB), a downlink channel (e.g., PDCCH or PDSCH that is scrambled using an identifier of the first UE 115-a (e.g., a radio network temporary identifier (RNTI)), or any combination thereof. In another example, if the first UE 115-a enters a new tracking area (TA) or RAN-based notification area (RNA) and re-registers with an associated network entity 105, the network entity 105 may provide the additional computation service information to the first UE 115-a.

In some cases, the additional computation service information may be associated with a change indication message indicating an update to the computation service information. The change indication message may be an extension to a short message or may be transmitted via a separate short message. The additional computation service information may indicate a validity duration, a version ID, a value tag, or any combination thereof, for a computation service. In some examples, the additional computation service information may be transmitted periodically (e.g., in accordance with a periodicity). In some other examples, the additional computation service information may be transmitted on-demand. In such examples, the first UE 115-a may transmit a computation status inquiry message to a network entity 105 (e.g., via (RACH signaling, via an uplink wakeup signal (UL-WUS)), or both. The computation status inquiry message may include information specific to the first computation service that is requested by the first UE 115-a. Upon receiving the computation status inquiry message, the network entity 105 may provide computation status information (e.g., the additional computation service information) to the first UE 115-a.

Although the techniques for cell selection discussed herein have been described with reference to a network entity 105 (e.g., communications between the first UE 115-a and a network entity 105), it should be noted that the techniques for cell selection also extend to direct communications between UEs 115 (e.g., sidelink communications). For example, the second UE 115-b and the third UE 115-c may provide corresponding computation service information to the first UE 115-a. Accordingly, the first UE 115-a may select one of the second UE 115-b or the third UE 115-c for sidelink communications based on the computation service information in a manner similar to selecting a cell 205 (e.g., network entity 105) as described herein.

In some examples, the first UE 115-a may prioritize selecting a cell (e.g., frequency) to receive or provide a computation service under one or more conditions. For example, if the first UE 115-a is receiving or interested to receive or provide a computation service(s) and may only receive or provide this service(s) by camping on a frequency or cell, or a group of cells on which it is provided, the first UE 115-a may consider that frequency, cell, or group of cells to be the highest priority during (or before) a computation service session. In some cases, the first UE 115-a may autonomously determine which frequency, cell, group of cells, or any combination thereof, to select, when the multiple frequencies, cells, group of cells, or any combination thereof, provide the computation service that is of interest to the first UE 115-a. In some cases, the first UE 115-a may follow a quality or strength-based (re)selection criteria for selecting a frequency, cell, group of cells, or any combination thereof, among the multiple frequencies, cells, group of cells, or any combination thereof, that provide the service that is of interest to the first UE 115-a.

If the first UE 115-a is receiving or interested to receive or provide a computation service, the first UE 115-a may consider cell reselection candidate frequencies at which the first UE 115-a is unable to receive or provide the service to be of the lowest priority during (or before) the service session.

By performing cell selection in accordance with computation service information, the first UE 115-a may benefit from enhanced energy efficiency, latency, and system resource utilization for cell selection. Specifically, in cases where the first UE 115-a is a client UE 115, the described techniques can be used to reduce connection establishment overhead and latency and may improve the quality of the computation service. Similarly, in cases where the first UE 115-a is a server UE 115, the described techniques can be used to facilitate more efficient usage of the first computation service supported by the first UE 115-a.

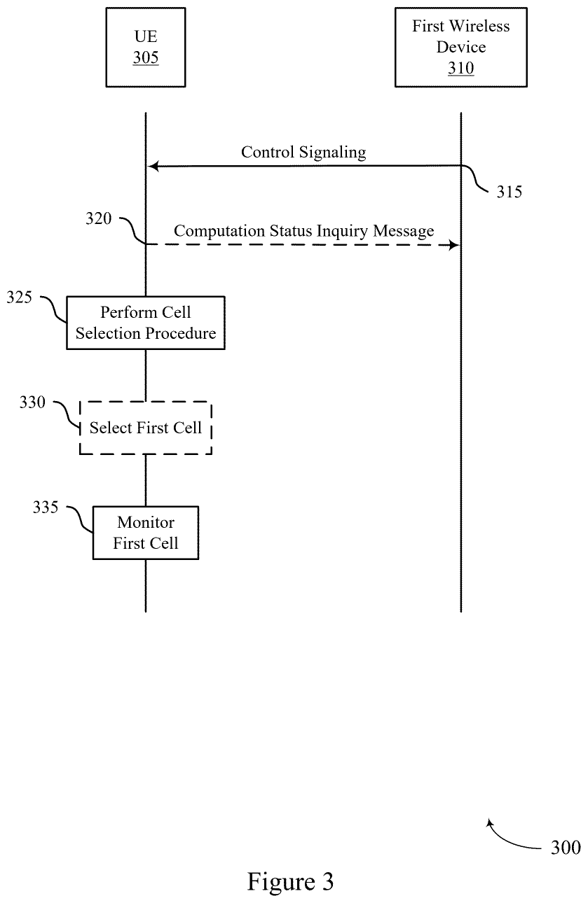

FIG. 3 shows an example of a process flow 300 that supports computation service-based cell selection for idle-mode mobility. The process flow 300 may implement or be implemented by aspects of the wireless communications system 100 and the signaling configuration 200 as described with reference to FIGS. 1 and 2. For example, the process flow 300 illustrates actions performed by a UE 305 and a first wireless device 310, which may be examples of corresponding devices described herein, including with reference to FIGS. 1 and 2. For example, the UE 305 may be an example of a first UE 115-a, and the first wireless device 310 may be an example of a first network entity 105-a or a second UE 115-b as described with reference to FIG. 2. In the following description of the process flow 300, the operations between the UE 305 and the first wireless device 310 may be performed in a different order than the example shown, or the operations between the UE 305 and the first wireless device 310 may be performed in different orders at different times. Some operations may also be omitted from the process flow 300, and other operations may be added to the process flow 300.

At 315, the UE 305 may receive control signaling including computation service information indicating one or more computational services supported by at least one of a plurality of wireless communication devices. In some examples, the computation service information may be for a network entity, where the plurality of wireless communication devices include one or more network entities. In some other examples, the computation service information may be for one or more wireless communication devices in communication with a network entity, where the one or more wireless communication devices include one or more second UEs, one or more edge computing devices, or any combination thereof. To receive the computation service information, the UE 305 may receive one or more messages carrying the computation service information via a broadcast channel.

In some examples, the computation service information may indicate a computation quality-of-service, a communication traffic type, a model type, an agent type, or any combination thereof, for the one or more computational services. In some other examples, the computation service information may indicate one or more computational service identifiers corresponding to the one or more computational services.

The computation service information may further include computation resource availability, computation service availability, a current computational load, computation service timing information, computation service pricing information, or any combination thereof. In some cases, the computation service information may be based on a service provider type, a computation service type included in the computation service information, timing information included in the computation service information, pricing information included in the computation service information, or any combination thereof. The UE 305 may receive one or more messages indicating to update a computation service configuration in accordance with the computation service information. In such cases, the computation service information may indicate a validity duration, a version identifier, or both. Additionally, or alternatively, the UE 305 may receive the computation service information in accordance with a periodicity.

In some examples, to receive the computation service information, the UE 305 may receive one or more SIBs including the computation service information. In a first example, the UE 305 may receive a first SIB of the one or more SIBs that indicates first computation service information. The first computation service information may indicate one or more computational services that are available, or a feature of the one or more computational services. The UE 305 may also receive a second SIB of the one or more SIBs that indicates second computation service information. The second computation service information may indicate one or more computational services that are available, or a feature of the one or more computational services..

In a second example, the UE 305 may receive a first SIB of the one or more SIBs that indicates the computation service information. The computation service information may indicate one or more computational services that are available, or a feature of the one or more computational services. The UE 305 may also receive one or more second SIBs of the one or more SIBs that indicates additional information about the one or more computational services.

In some cases, to receive the computation service information, the UE 305 may acquire one or more cell identifiers corresponding to at least one cell including the first cell. In such cases, the UE 305 may select the first cell based on the one or more cell identifiers.

At 320, the UE 305 may transmit a computation status inquiry message (e.g., to the first wireless device 310). In some cases, the computation status inquiry message may indicate information for the first computational service. The control signaling including the computation service information may be received by the UE 305 based on the computation status inquiry message.

At 325, the UE 305 may perform, based on the computation service information, a cell selection procedure to select a first cell corresponding to a first wireless communication device of the plurality of wireless communication devices. The computation service information may indicate that a first computational service of the one or more computational services is supported by the first wireless communication device via the first cell.

At 330, to perform the cell selection procedure, the UE 305 may select the first cell in accordance with a priority of at least one cell including the first cell. In such cases, the priority may be based on the computation service information. For example, the priority may be based on whether a respective wireless communication device of the plurality of wireless communication devices supports the first computational service. Additionally, or alternatively, the priority may be further based on at least one criterion, the at least one criterion including: channel quality, channel strength, a traffic load, a computational load, service availability, a type of the first computational service, or any combination thereof. At 335, the UE 305 may monitor the first cell for signaling from the first wireless communication device based at least in part on the cell selection procedure.

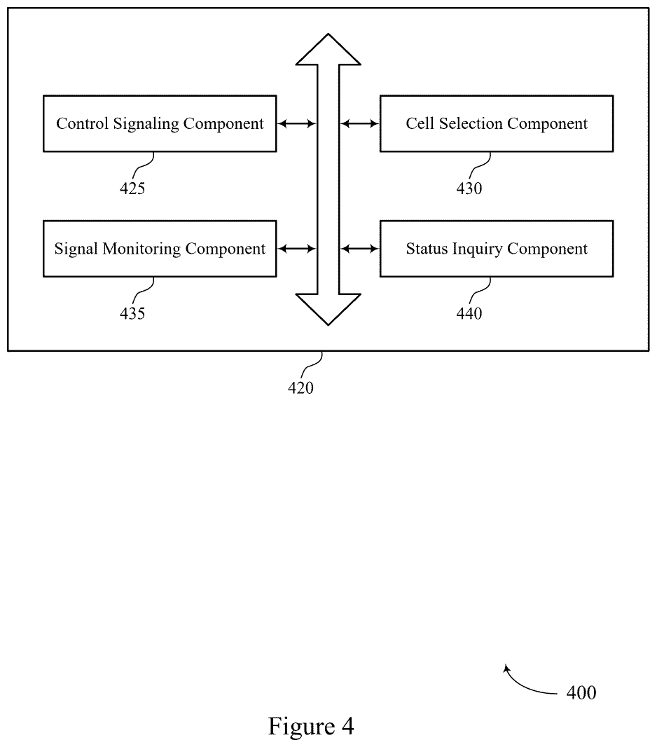

FIG. 4 shows an example 400 of a processing system 420 that supports computation service-based cell selection for idle-mode mobility. A processing system 420 may be an example of a processing system 140 (such as of a UE 115) and may include a control signaling component 425, a cell selection component 430, a signal monitoring component 435, a status inquiry component 440, or any combination thereof. A processing system 420, or various component thereof, may be an example of means for performing (such as a means for causing a UE 115 to perform) various techniques described herein.

The control signaling component 425 may be configured to cause the UE 115 to receive control signaling including computation service information indicating one or more computational services supported by at least one of a set of multiple wireless communication devices. The cell selection component 430 may be configured to cause the UE 115 to perform, based on the computation service information, a cell selection procedure to select a first cell corresponding to a first wireless communication device of the set of multiple wireless communication devices, where the computation service information indicates that a first computational service of the one or more computational services is supported by the first wireless communication device via the first cell. The signal monitoring component 435 may be configured to cause the UE 115 to monitor the first cell for signaling from the first wireless communication device based on the cell selection procedure.

In some examples, the computation service information may indicate a computation quality-of-service, a communication traffic type, a model type, an agent type, or any combination thereof, for the one or more computational services.

In some examples, the computation service information may indicate one or more computational service identifiers corresponding to the one or more computational services.

In some examples, to support performing the cell selection procedure, the cell selection component 430 may be configured to cause the UE 115 to select the first cell in accordance with a priority of at least one cell including the first cell, where the priority is based on the computation service information.

In some examples, the priority is based on whether a respective wireless communication device of the set of multiple wireless communication devices supports the first computational service.

In some examples, the priority is further based on at least one criterion, the at least one criterion including: channel quality, channel strength, a traffic load, a computational load, service availability, a type of the first computational service, or any combination thereof.

In some examples, to support receiving the computation service information, the control signaling component 425 may be configured to cause the UE 115 to receive one or more system information blocks including the computation service information.

In some examples, a first system information block of the one or more system information blocks indicates first computation service information, the first computation service information indicating one or more computational services that are available, or a feature of the one or more computational services; and a second system information block of the one or more system information blocks indicates second computation service information, the second computation service information indicating one or more computational services that are available, or a feature of the one or more computational services.

In some examples, a first system information block of the one or more system information blocks indicates the computation service information, the computation service information indicating one or more computational services that are available, or a feature of the one or more computational services; and one or more second system information blocks of the one or more system information blocks indicates additional information about the one or more computational services.

In some examples, to support receiving the computation service information, the control signaling component 425 may be configured to cause the UE 115 to acquire one or more cell identifiers corresponding to at least one cell including the first cell, where the first cell is selected based on the one or more cell identifiers.

In some examples, the computation service information includes: computation resource availability, computation service availability, a current computational load, computation service timing information, computation service pricing information, or any combination thereof.

In some examples, the computation service information is for a network entity. In some examples, the set of multiple wireless communication devices include one or more network entities.

In some examples, the computation service information is for one or more wireless communication devices in communication with a network entity. In some examples, the one or more wireless communication devices include one or more second UEs, one or more edge computing devices, or any combination thereof.

In some examples, the computation service information is based on a service provider type, a computation service type included in the computation service information, timing information included in the computation service information, pricing information included in the computation service information, or any combination thereof.

In some examples, to support receiving the computation service information, the control signaling component 425 may be configured to cause the UE 115 to receive one or more messages carrying the computation service information via a broadcast channel.

In some examples, to support receiving the computation service information, the control signaling component 425 may be configured to cause the UE 115 to receive one or more messages indicating to update a computation service configuration in accordance with the computation service information.

In some examples, the computation service information indicates a validity duration, a version identifier, or both.

In some examples, to support receiving the computation service information, the control signaling component 425 may be configured to cause the UE 115 to receive the computation service information in accordance with a periodicity.

In some examples, the status inquiry component 440 may be configured to cause the UE 115 to transmit a computation status inquiry message, where the control signaling including the computation service information is received based on the computation status inquiry message.

In some examples, the computation status inquiry message indicates information for the first computational service.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for improved communication reliability, reduced latency, improved user experience related to reduced processing, reduced power consumption, more efficient utilization of communication resources, improved coordination between devices, and improved utilization of processing capability.

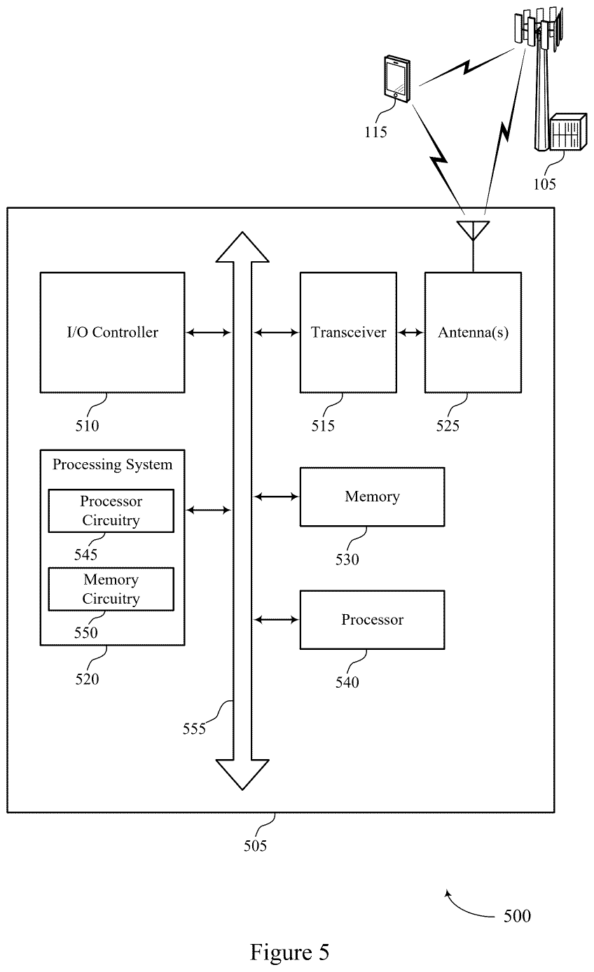

FIG. 5 shows an example of a system 500 including a device 505 that supports computation service-based cell selection for idle-mode mobility. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support computation service-based cell selection for idle-mode mobility. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, reduced latency, improved user experience related to reduced processing, reduced power consumption, more efficient utilization of communication resources, improved coordination between devices, and improved utilization of processing capability.

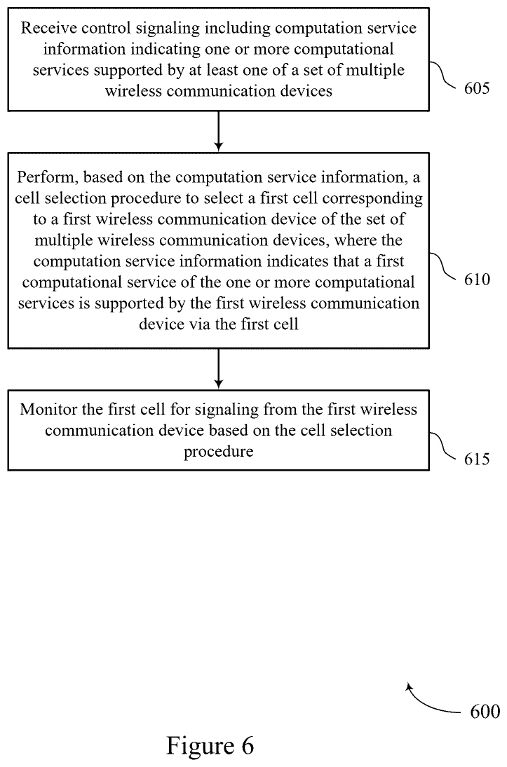

FIG. 6 shows an example of a method 600 that supports computation service-based cell selection for idle-mode mobility. Operations of the method 600 may be performed by a UE or its components (such as using a processing system configured to cause the UE 115 to perform one or more of the operations) as described herein.

At 605, the method may include receiving control signaling including computation service information indicating one or more computational services supported by at least one of a set of multiple wireless communication devices. In some examples, aspects of the operations of 605 may be performed by a control signaling component 425.

At 610, the method may include performing, based on the computation service information, a cell selection procedure to select a first cell corresponding to a first wireless communication device of the set of multiple wireless communication devices, where the computation service information indicates that a first computational service of the one or more computational services is supported by the first wireless communication device via the first cell. In some examples, aspects of the operations of 610 may be performed by a cell selection component 430.

At 615, the method may include monitoring the first cell for signaling from the first wireless communication device based on the cell selection procedure. In some examples, aspects of the operations of 615 may be performed by a signal monitoring component 435.

Implementation examples are described in the following numbered clauses:
Aspect 1: A method for wireless communication at a UE, comprising: receiving control signaling comprising computation service information indicating one or more computational services supported by at least one of a plurality of wireless communication devices; performing, based at least in part on the computation service information, a cell selection procedure to select a first cell corresponding to a first wireless communication device of the plurality of wireless communication devices, wherein the computation service information indicates that a first computational service of the one or more computational services is supported by the first wireless communication device via the first cell; and monitoring the first cell for signaling from the first wireless communication device based at least in part on the cell selection procedure.
Aspect 2: The method of aspect 1, wherein the computation service information indicates a computation quality-of-service, a communication traffic type, a model type, an agent type, or any combination thereof, for the one or more computational services.
Aspect 3: The method of any of aspects 1 through 2, wherein the computation service information indicates one or more computational service identifiers corresponding to the one or more computational services.
Aspect 4: The method of any of aspects 1 through 3, wherein performing the cell selection procedure further comprises: selecting the first cell in accordance with a priority of at least one cell comprising the first cell, wherein the priority is based at least in part on the computation service information.
Aspect 5: The method of aspect 4, wherein the priority is based at least in part on whether a respective wireless communication device of the plurality of wireless communication devices supports the first computational service.
Aspect 6: The method of any of aspects 4 through 5, wherein the priority is further based at least in part on at least one criterion, the at least one criterion comprising channel quality, channel strength, a traffic load, a computational load, service availability, a type of the first computational service, or any combination thereof.
Aspect 7: The method of any of aspects 1 through 6, wherein receiving the computation service information further comprises: receiving one or more system information blocks comprising the computation service information.
Aspect 8: The method of aspect 7, wherein a first system information block of the one or more system information blocks indicates first computation service information, the first computation service information indicating one or more computational services that are available, or a feature of the one or more computational services; and a second system information block of the one or more system information blocks indicates second computation service information, the second computation service information indicating one or more computational services that are available, or a feature of the one or more computational services.
Aspect 9: The method of aspect 7, wherein a first system information block of the one or more system information blocks indicates the computation service information, the computation service information indicating one or more computational services that are available, or a feature of the one or more computational services; and one or more second system information blocks of the one or more system information blocks indicates additional information about the one or more computational services.
Aspect 10: The method of any of aspects 1 through 9, wherein receiving the computation service information further comprises: acquiring one or more cell identifiers corresponding to at least one cell comprising the first cell, wherein the first cell is selected based at least in part on the one or more cell identifiers.
Aspect 11: The method of any of aspects 1 through 10, wherein the computation service information comprises: computation resource availability, computation service availability, a current computational load, computation service timing information, computation service pricing information, or any combination thereof.
Aspect 12: The method of any of aspects 1 through 11, wherein the computation service information is for a network entity, and the plurality of wireless communication devices comprise one or more network entities.
Aspect 13: The method of any of aspects 1 through 12, wherein the computation service information is for one or more wireless communication devices in communication with a network entity, and the one or more wireless communication devices comprise one or more second UEs, one or more edge computing devices, or any combination thereof.
Aspect 14: The method of any of aspects 1 through 13, wherein the computation service information is based at least in part on a service provider type, a computation service type included in the computation service information, timing information included in the computation service information, pricing information included in the computation service information, or any combination thereof.
Aspect 15: The method of any of aspects 1 through 14, wherein receiving the computation service information further comprises: receiving one or more messages carrying the computation service information via a broadcast channel.
Aspect 16: The method of any of aspects 1 through 15, wherein receiving the computation service information further comprises: receiving one or more messages indicating to update a computation service configuration in accordance with the computation service information.
Aspect 17: The method of any of aspects 1 through 16, wherein the computation service information indicates a validity duration, a version identifier, or both.
Aspect 18: The method of any of aspects 1 through 17, wherein receiving the computation service information further comprises: receiving the computation service information in accordance with a periodicity.
Aspect 19: The method of any of aspects 1 through 18, further comprising: transmitting a computation status inquiry message, wherein the control signaling comprising the computation service information is received based at least in part on the computation status inquiry message.
Aspect 20: The method of aspect 19, wherein the computation status inquiry message indicates information for the first computational service.
Aspect 21: A UE for wireless communication, comprising a processing system that includes processor circuitry and memory circuitry that stores code, the processing system configured to cause the UE to perform a method of any of aspects 1 through 20.
Aspect 22: A UE for wireless communication, comprising at least one means for performing a method of any of aspects 1 through 20.
Aspect 23: A non-transitory computer-readable medium storing code for wireless communication, the code comprising instructions executable by one or more processors to perform a method of any of aspects 1 through 20.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as CPUs, GPUs, neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, ADCs, or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling comprising computation service information indicating one or more computational services supported by at least one of a plurality of wireless communication devices;
perform, based at least in part on the computation service information, a cell selection procedure to select a first cell corresponding to a first wireless communication device of the plurality of wireless communication devices, wherein the computation service information indicates that a first computational service of the one or more computational services is supported by the first wireless communication device via the first cell; and
monitor the first cell for signaling from the first wireless communication device based at least in part on the cell selection procedure.

2. The UE of claim 1, wherein the computation service information indicates a computation quality-of-service, a communication traffic type, a model type, an agent type, or any combination thereof, for the one or more computational services.

3. The UE of claim 1, wherein the computation service information indicates one or more computational service identifiers corresponding to the one or more computational services.

4. The UE of claim 1, wherein, to perform the cell selection procedure, the processing system is further configured to cause the UE to:
select the first cell in accordance with a priority of at least one cell comprising the first cell, wherein the priority is based at least in part on the computation service information.

5. The UE of claim 4, wherein the priority is based at least in part on whether a respective wireless communication device of the plurality of wireless communication devices supports the first computational service.

6. The UE of claim 4, wherein the priority is further based at least in part on at least one criterion, the at least one criterion comprising: channel quality, channel strength, a traffic load, a computational load, service availability, a type of the first computational service, or any combination thereof.

7. The UE of claim 1, wherein, to receive the computation service information, the processing system is further configured to cause the UE to:
receive one or more system information blocks comprising the computation service information.

8. The UE of claim 7, wherein:
a first system information block of the one or more system information blocks indicates first computation service information, the first computation service information indicating one or more computational services that are available, or a feature of the one or more computational services; and
a second system information block of the one or more system information blocks indicates second computation service information, the second computation service information indicating one or more computational services that are available, or a feature of the one or more computational services.

9. The UE of claim 7, wherein:
a first system information block of the one or more system information blocks indicates the computation service information, the computation service information indicating one or more computational services that are available, or a feature of the one or more computational services; and
one or more second system information blocks of the one or more system information blocks indicates additional information about the one or more computational services.

10. The UE of claim 1, wherein, to receive the computation service information, the processing system is further configured to cause the UE to:
acquire one or more cell identifiers corresponding to at least one cell comprising the first cell, wherein the first cell is selected based at least in part on the one or more cell identifiers.

11. The UE of claim 1, wherein the computation service information is for a network entity, and wherein the plurality of wireless communication devices comprise one or more network entities.

12. The UE of claim 1, wherein the computation service information is for one or more wireless communication devices in communication with a network entity, and wherein the one or more wireless communication devices comprise one or more second UEs, one or more edge computing devices, or any combination thereof.

13. The UE of claim 1, wherein the computation service information is based at least in part on a service provider type, a computation service type included in the computation service information, timing information included in the computation service information, pricing information included in the computation service information, or any combination thereof.

14. The UE of claim 1, wherein, to receive the computation service information, the processing system is further configured to cause the UE to:
receive one or more messages carrying the computation service information via a broadcast channel.

15. The UE of claim 1, wherein, to receive the computation service information, the processing system is further configured to cause the UE to:
receive one or more messages indicating to update a computation service configuration in accordance with the computation service information.

16. The UE of claim 1, wherein the computation service information indicates a validity duration, a version identifier, or both.

17. The UE of claim 1, wherein, to receive the computation service information, the processing system is further configured to cause the UE to:
receive the computation service information in accordance with a periodicity.

18. The UE of claim 1, wherein the processing system is further configured to cause the UE to:
transmit a computation status inquiry message indicating information for the first computational service, wherein the control signaling comprising the computation service information is received based at least in part on the computation status inquiry message.

19. A method for wireless communication at a user equipment (UE), comprising:
receiving control signaling comprising computation service information indicating one or more computational services supported by at least one of a plurality of wireless communication devices;
performing, based at least in part on the computation service information, a cell selection procedure to select a first cell corresponding to a first wireless communication device of the plurality of wireless communication devices, wherein the computation service information indicates that a first computational service of the one or more computational services is supported by the first wireless communication device via the first cell; and
monitoring the first cell for signaling from the first wireless communication device based at least in part on the cell selection procedure.

20. A non-transitory computer-readable medium storing code for wireless communication, the code comprising instructions executable by one or more processors to:
receive control signaling comprising computation service information indicating one or more computational services supported by at least one of a plurality of wireless communication devices;
perform, based at least in part on the computation service information, a cell selection procedure to select a first cell corresponding to a first wireless communication device of the plurality of wireless communication devices, wherein the computation service information indicates that a first computational service of the one or more computational services is supported by the first wireless communication device via the first cell; and
monitor the first cell for signaling from the first wireless communication device based at least in part on the cell selection procedure.
